(19) United States
(12) Patent Application Publication
(10) Pub. No.: US 2008/0176017 A1
(43) Pub. Date: Jul. 24, 2008

(54) Release liner with enhanced backside or second side

(76) Inventors: Kristen Gouge, Oak Creek, WI (US); Kevin D. Rea, Wauwatosa, WI (US)

Correspondence Address: MCDERMOTT, WILL & EMERY LLP, 227 WEST MONROE STREET, SUITE 4400, CHICAGO, IL, 60606-5096, US

(21) Appl. No.: 11/654,952

(22) Filed: Jan. 18, 2007

(51) Int. Cl. B32B 27/40; B32B 27/30; B32B 27/32; B32B 29/00; B32B 27/18

(52) U.S. Cl. 428/40.2; 428/411.1; 428/327; 428/423.1; 428/522; 428/323; 428/537.5; 428/523

(57) ABSTRACT

A release liner having a generally flat first substrate, with a first side and a second side. The first side includes a first coating, providing release against a pressure-sensitive adhesive, when that pressure sensitive adhesive is contacted with the first side. The release liner also includes a. second, preferably solvent-free, curable coating for application to the second side of the release liner. That coating comprises a mixture, the mixture having two pre-polymer components, the first pre-polymer component comprising at least one monomer, and the second pre-polymer component comprising either (a) at least one oligomer or (b) at least one soluble resin. The coating further comprises insoluble non-mineral type particles within that mixture. The insoluble non-mineral type particles preferably comprise an insoluble polymer powder, and most preferably an insoluble polyamide powder.

### CROSS-REFERENCE TO RELATED APPLICATIONS

None.

### FEDERALLY SPONSORED RESEARCH OR DEVELOPMENT

Not applicable.

### TECHNICAL FIELD

This invention is directed to a new release liner, that does not use a polymer-bound mineral particle layer.

### BACKGROUND OF THE INVENTION

Release liners are well known in the art. Release liners are used to protect the adhesive that is found on one side of a product intended to be adhered to another surface. Release liners are used in labels, tapes, and various rubber and sealant products.

The typical release liner used for labels includes a flat base substrate. That substrate may be coated on both sides. One example of a suitable coating is a thermoplastic polyolefin.

A first side of the substrate may include a release coating, enabling an adhesive to be readily released from that side of the substrate. The second side may include a solvent based coating, useful for imprintable applications.

U.S. Pat. No. 5,962,098, entitled “Release Liner,” issued to Wilhelm Munninger and Hans Wattendorf (hereinafter “Munninger et al.”). This patent is directed to a release liner having a flat base substrate coated on both sides with a thermoplastic polyolefin and having a release coating on its first side. The release coating provides a release characteristic for adhesives.

More specifically, the release liner has a release coating on the first side of the base substrate coated with the polyolefin, and a polymer-bound mineral particle layer on the second side. The mineral particle layer clearly appears to be an important component of the Munninger et al. invention.

Munninger et al. state that the objects of the invention are to create a release liner that will withstand greater thermal stress, and can be adequately written on or imprinted on its second side. In addition, objects of Munninger et al. are a release liner that does not tend to undergo changes in friction behavior, nor experience blocking.

Munninger et al. states that it is the small layer thickness which results in the paper-like surface properties of the layer. The mineral component of the polymer-bound mineral particle layer can consist of kaolin, chalk, or silicon dioxide. The mineral component appears to be an essential part of the Munninger et al. invention.

Other generally relevant patents and applications include U.S. Pat. Nos. 7,037,564; 6,623,824; 6,478,918; 6,326,072; 6,235,387; 6,221,485; 5,968,996; 5,658,661; 4,533,600; 4,241,198; and U.S. Published Application Nos. 2003/0192638; 2002/0028326; 2002/001304; 2006/0167180; 2005/0214531; 2005/0214528; 2005/0170126; 2006/0177654; and 2004/0106693.

### SUMMARY OF THE INVENTION

The inventors have discovered a way of making a suitable release liner without a polymer-bound mineral particle layer, and without the need for mineral particles that may be comprised of kaolin, chalk, or silicon dioxide.

The invention is a release liner. The liner comprises a generally flat first substrate having a first side and a second side

The first side includes a first coating, providing release against a pressure-sensitive adhesive, when that pressure sensitive adhesive is contacted with the first side.

The release liner also includes a second, solvent-free, curable coating for application to the second side of the release liner. That coating comprises a mixture having at least one monomer, and at least one oligomer or one soluble resin; and insoluble, non-mineral type particles within that mixture. Preferably, this second coating is solvent-free, i.e., it includes 100% solids, and is curable by ultraviolet light or electron beam to form a polymer matrix. Particularly, a polymer matrix is formed after the polymerization of the coating containing the insoluble, non-mineral type particles. As will be explained below, this polymerization can be induced by means of ultraviolet light or electron beam exposure, or by other curing means.

Preferably, the insoluble, non-mineral type particles comprise a polymer powder. The most preferred type of polymer powder is an insoluble polyamide powder. Insoluble polymer powders may include polyamides, polyolefins, polyurethanes, or polytetrafluoroethylene (PTFE). Examples of commercially available insoluble polymer powders are available from Micro Powders Inc. (www.micropowders.com). The insoluble polymer or polyamide powder may have an average size (i.e. diameter) of from 1 to 20 microns. In a more preferred embodiment, the insoluble polyamide powder may have an average size of between 5 and 15 microns. In the most preferred embodiment, the insoluble polyamide powder may have an average size or diameter of between 5 and 10 microns. The insoluble powder may be present in an amount of approximately 20% (wt.). It is important that an insoluble powder be used, so that the powder will remain a discrete, discernable part of the coating, as opposed to a dissolved and non-discernable part of the polymer film that is ultimately formed. It should also be understood that these preferred powders, in the form in which they are obtained from their manufacturer, are already polymerized. The powders that are a part of the coating thus do not change in form or structure during the curing process. That curing process does, however, result in the polymerization of any pre-polymer components of that coating.

The mixture of at least one monomer, and at least one oligomer or one soluble resin, which forms the coating composition, and which ultimately results in the polymer matrix, may preferably comprise at least one acrylate monomer. Acrylate monomers may be monofunctional or multifunctional with a functionality up to about 6. Examples of commercially available acrylate monomers are available from Sartomer, Inc. (SR brand products), or Cytec Inc. (Ebecryl brand products). In a most preferred embodiment, the total amount of acrylate monomer may be between 50% and 56%, by weight.

The mixture of at least one monomer, and at least one oligomer or one soluble resin, may include a photoinitiator, preferably in an amount of from 1-8%, and most preferably in an amount of about 3%. Preferred photoinitiators for use with acrylates are free-radical photoinitiators. Suitable commercial photoinitiators are available from Ciba Geigy and Lamberti.

The mixture may further include a stabilizer, present in an amount of from 0.1% to 1.0% (wt.).

The mixture may further include, as its oligomer, a urethane acrylate oligomer, present in an amount of from 10 to 60%, and most preferably in an amount of approximately 25%. Other suitable acrylate oligomers include acrylated epoxy, acrylated polyester, and acrylated acrylic oligomers.

If the mixture includes a soluble resin instead of the oligomer, then a most preferred resin is a chlorinated paraffin, present in an amount of 15-25%, and most preferably in an amount of approximately 20%. Soluble resins may include, but are not limited to, chlorinated paraffins, hydrocarbon resins, acrylic resins, polyester resins, and various natural product derived resin materials.

The second coating may be cured by any number of means. For example, the second coating may be cured by actinic radiation, which includes an electron beam. Typical electron beam generating equipment is available from Energy Sciences, Inc. Typical electron beam dosage is from about 1 to 6 Mrads, and typical electron beam voltage is from 70 to 200 kV.

The second coating may also be cured by ultraviolet light. Preferably, this second coating is cured by ultraviolet light in an inert atmosphere. A typical UV lamp is a medium pressure mercury lamp. Such lamps can include those that are energized by an electrical arc or by microwaves. Typical lamp input energy is 200 to 600 watts/inch.

As noted above, the most preferred second coating is comprised of 100% solids, i.e., is solvent-free, and is curable by ultraviolet light. However, this second coating may also be diluted by a solvent or a water carrier. In this instance, after the second coating is applied to the substrate, the solvent is evaporated from the second coating, and the second coating is cured by ultraviolet light. The mixture of at least one monomer, and at least one oligomer or one soluble resin, upon the evaporation of the solvent or water carrier, forms a film Alternatively, this mixture, upon the chemical reaction between at least two pre-polymer components, forms a film. This is evidenced by the fact that subsequent to curing, as for example by ultraviolet treatment, the formerly liquid or tacky second coating is transformed to a non-tacky, dried polymeric film.

Finally, the substrate of the invention may be paper, or a polymer film. A preferred paper substrate includes a polyolefin layer on at least one of the first and second surfaces. This polyolefin layer may, for example, enhance the adhesive release characteristics of the first side of the substrate. The second coating may be placed on the substrate in varying amounts. Preferably, the coating weight should be in a range of between 0.1 to 1.5 pounds per ream. Most preferably, the second coating is placed on the substrate in an amount of between 0.4 and 0.9 pounds per ream.

The second side (or backside) of substrates treated with the second coating of the invention has improved characteristics. Particularly, the second side of the release liner made with the second coating, in accordance with the invention, has an improved polymer matrix and may also be rougher, providing increased friction with the rollers of existing printers. As a result, the substrate is more easily transported through existing printers. This in turn lowers the incidence of jamming, especially when more than one sheet is being transported through the printers.

The increased roughness on the second side of the substrate provides still further advantages. Paper is fed to printers from adjacent trays. One hundred or more sheets of paper are typically stacked in these trays. In order for a single sheet to be properly fed from the tray and to the printer, it must be cleanly separable from the sheet immediately below.

If the adjacent sheets are overly smooth, however, there will be an inadequate spacing between the sheets, increasing the likelihood of a multiple sheet feed to the printer, and increasing the likelihood of the printer jamming.

This problem is overcome by the present invention. The present invention increases the roughness of the second side of the sheet, and thereby increases the spacing and decreases the friction between that sheet and the adjacent sheet in a paper tray. This reduces the likelihood of the feeding of multiple sheets into, and the resultant jamming of, the printer. The increased roughness of the second side of these sheets also improves the handling characteristics of substrates used in graphic arts applications.

In addition, the second coating of the present invention uses, in lieu of a mineral-type additive, a non-mineral type additive, and most preferably an organic additive. Again, a preferred organic additive is a polymer powder, and a most preferred organic additive is a polyamide powder. There are many advantages to the use of such an organic additive in the second coating of the invention, including that it creates a tough, finished surface on the substrate that does not create a fine “dust” during abrasive handling operations, or during printing operations. Such a “dust” can lower the efficiency of the manufacture of the release liner, and may also compromise the quality of printing in the final release liner product, during printing operations.

It has also been found that the second coating, with its non-mineral type additive, is somewhat easier to apply to a substrate than a coating made with mineral type additives.

### DETAILED DESCRIPTION

There are many possible embodiments of this invention. The description below describes in detail a preferred embodiment of the invention. It should be understood that the present disclosure is to be considered as an example of the principles of the invention. The disclosure is not intended to limit the broad aspect of the invention to the embodiments illustrated.

The invention may best be appreciated by a review of two preferred Examples of the invention, which are set forth in Example 1 (with the composition listed in Table 1) and Example 4 (with the composition listed in Table 2). These Examples are preferred embodiments of the so-called second coating of the invention.

Example 2 demonstrates the placement of the second coating of Example 1 onto a substrate. Example 3 provides an evaluation of the characteristics of the coated substrate of Example 2.

Similarly, Example 5 demonstrates the placement of the second coating of Example 4 onto a substrate. Example 6 provides an evaluation of the characteristics of the coated substrate of Example 5.

### EXAMPLE 1

A solvent-free, UV-curable second coating composition was prepared by blending the materials shown in the below Table 1. The resulting composition is a free-flowing composition with a viscosity of approximately 550 cps at 25 degrees Celsius. The components form a homogeneous liquid except for the polyamide powders, which are insoluble. The polyamide powders are dispersed in the liquid composition. The two pre-polymer components in this Table 1 are (a) the three acrylate monomers and (b) the urethane acrylate oligomer.

TABLE 1

| Weight % | Trade Name | Chemical Name | Description |
|---|---|---|---|
| 19.4 | HDODA | Hexanediol diacrylate | Acrylate monomer |
| 0.005 | None | Phenothiazene | Stabilizer |
| 2.0 | KIP 150 | Oligo (2-hydroxy-2-methyl-1-4 (1- | Polymeric Photoinitiator |
| | | methylvinyl) phenyl propanone | |
| 25.0 | Ebecryl | Urethane acrylate oligomer (with | Urethane acrylate |
| | 8800-20R | 20% TRPGDA and 8% EOEOEA | oligomer (with acrylate |
| | | monomer diluents) | monomer diluents) |
| 15.095 | TMPTA | Trimethylol propane triacrylate | Acrylate monomer |
| 0.5 | Lucirin TPO | 2,4,6 trimethylbenzoyldiphenyl | Photoinitiator |
| | | phosphine oxide | |
| 10.0 | Orgosol | Polyamide powder | 10 micron average size |
| | 2001 EXD | | insoluble polymer power |
| | Nat 1 | | |
| 10.0 | Orgosol | Polyamide powder | 5 micron average size |
| | 2001 UD | | insoluble polymer |
| | Nat 1 | | powder |
| 16.0 | SR506 | Isobornyl acrylate | Acrylate monomer |
| 2.0 | Darocur | 2-hydroxy-2-methyl-1-phenyl-1- | Photoinitiator |
| | 1173 | propanone | |

### EXAMPLE 2

The composition of Example 1/Table 1 was applied to a web of 97# polycoated Kraft paper, as the substrate, using a 5 roll coater, at a speed of 500 ft/min to give a coating weight of 0.8 grams per square meter (gsm). The coating was UV cured by exposure to four (4) ultraviolet lamps operating at a power of 225 watts per inch, for a total of 900 watts per inch. Exposure of the coating occurred in an inert, nitrogen atmosphere.

### EXAMPLE 3

The coated release liner of Example 2 is a commercially acceptable product. The product resulting from the above-described process has one of its sides coated with silicone, and the other of its sides coated with the coating of Table 1. An adhesive is then applied to the silicone-coated side, and a vinyl film is nipped over that adhesive. The vinyl film side of the resulting release liner/vinyl film laminate may be subjected to multi-registration printing. After printing, the laminate is cut into sheets. In many different applications, the sheets may subsequently be stacked. The backside coating, which is formed by the application and curing of the coating listed in Table 1, acts as a friction coating, which inhibits the sticking together of adjacent sheets. This characteristic is useful when sheets are stacked together, as for example in connection with so-called shelf talkers in grocery stores.

### EXAMPLE 4

A solvent-free UV curable coating composition was prepared by blending the materials shown in the below Table 2. The resulting composition is a free flowing liquid with a viscosity of approximately 550 cps at 25 degrees Celsius. The components form a homogeneous liquid, except for the polyamide powders which are insoluble

The polyamide powders are dispersed in the liquid composition. The two pre-polymer components in this Table 2 are (a) the four acrylate monomers and (b) the resin, in this case a chlorinated paraffin resin.

TABLE 2

| Weight % | Trade Name | Chemical Name | Description |
|---|---|---|---|
| 42.95 | Ebecryl 110 | Ethoxylated phenoxyethyl acrylate | Acrylate monomer |
| 0.005 | N/A | Phenothiazene | Stabilizer |
| 0.5 | BHT | Butylated hydroxytolune | Stabilizer |
| 0.4 | N/A | NPAL solution in TMPTA | Stabilizer |
| 0.05 | UVitex OB | 2,2′-(2,5-thiophenediyl)bis[5-(tert)- | Optical brightener |
| | | butylbenzoxazole] | |
| 20.0 | Chlorex 700 | Chlorinated paraffin | Resin |
| | LSP | | |
| 5.0 | MAES | Monoacryloxyethyl succinate | Acrylate monomer |
| 5.0 | MAHP | Monoacryloxyethyl | Acrylate monomer |
| | | hexahydrophthalate | |
| 10.0 | Orgosol | Polyamide powder | 10 micron average size |
| | 2001 EXD | | insoluble polymer power |
| | Nat 1 | | |
| 10.0 | Orgosol | Polyamide powder | 5 micron average size |
| | 2001 UD | | insoluble polymer |
| | Nat 1 | | powder |
| 3.095 | TMPTA | Trimethylol propane triacrylate | Acrylate monomer |
| 3.0 | Darocur | 2-hydroxy-2-methyl-1-phenyl-1- | Photoinitiator |
| | 1173 | propanone | |

### EXAMPLE 5

The composition of Example 4/Table 2, was applied to a web of 97# polycoated Kraft paper, as the substrate, using a 5-roll coater at a speed of 500 ft/min to give a coating weight of 0.8 grams per square meter (gsm). The coating was UV cured by exposure to four (4) ultraviolet lamps operating at a power of 225 watts per inch, for a total of 900 watts per inch. Exposure of the coating occurred in a nitrogen atmosphere.

### EXAMPLE 6

The coated release liner of Example 5 is a commercially acceptable product. The product resulting from the above-described process has one of its sides coated with silicone, and the other of its sides coated with the coating of Table 2. An adhesive is then applied to the silicone-coated side, and a vinyl film is nipped over that adhesive. The vinyl film side of the resulting release liner/vinyl film laminate may be subjected to the application of multi-registration graphics, in web form. The opposite side of the laminate, i.e., the side of the laminate coated with the friction coating of Table 2 (“the friction coated side”), may also be printed upon. Typical graphics for this side of the laminate can include single-color trademark or product identification graphics. The printed product may then be sheeted, including in large formats, as for example, in sizes that are suitable for use in bus advertising.

An additional application of the invention described above is in the medical field, as for example, in connection with ostomy bags. Labels made in accordance with the invention have the adhesive side facing and applied directly to the outer wall of the ostomy bag. This leaves the friction coated side of the label facing the user of, or the medical professional fitting, the ostomy bag. As a result of its rougher surface, the friction coated side readily accepts mechanized printing. Particularly, laser ink is readily dried and anchored onto this friction coated side. This rougher surface also readily accepts manual ink pen writing of customized information, by the health-care professional, upon the friction coated side.

The most preferred Example of the invention is that shown in Table 2, which provided superior printability. Specifically, the Example of Table 2 provides a substrate that readily receives and retains both laser print, and conventional, ball-point pen-sourced ink printing. It may be seen that the second coating of this invention imparts to a substrate a lower coefficient of friction (COF) to the second side of the substrate, when compared to the standard poly matte surfaces. As suggested above, this characteristic results in the improved feeding of the paper sheets used in laser printing applications.

In testing against both a competitive product of a third party, and the assignee's current line of comparable products, release liners made in accordance with the present invention demonstrated commercially acceptable characteristics.

While specific embodiments have been illustrated and described, numerous modifications come to mind without significantly departing from the spirit of the invention, and the scope of protection is only limited by the scope of the accompanying Claims.

What is claimed is:

1. A release liner comprising:
a generally flat first substrate having a first side and a second side;
a first coating providing release against a pressure-sensitive adhesive, when that pressure sensitive adhesive is contacted with said first side; and
a second, curable, solvent-free coating for application to said second side, said second coating comprising both a mixture having two pre-polymer components, the first pre-polymer component comprising at least one monomer, and the second pre-polymer component comprising either (a) at least one oligomer or (b) at least one soluble resin; and said curable, solvent-free coating further comprising insoluble, non-mineral type particles within that mixture.

2. The release liner of claim 1, wherein the insoluble, non-mineral type particles comprise an insoluble polymer powder.

3. The release liner of claim 2, wherein said insoluble polymer powder comprises an insoluble polyamide powder.

4. The release liner of claim 3, wherein the insoluble polyamide powder has an average size of between 5 microns and 10 microns.

5. The release liner of claim 1, wherein the mixture comprises an acrylate monomer.

6. The release liner of claim 5, wherein the mixture further comprises a photoinitiator.

7. The release liner of claim 6, wherein the mixture further comprises a stabilizer.

8. The release liner of claim 7, wherein the mixture further comprises a urethane acrylate oligomer.

9. The release liner of claim 3, wherein the insoluble polyamide powder is present in an amount of approximately 20% (wt.).

10. The release liner of claim 5, wherein the acrylate monomer is present in an amount of approximately 50%-56% (wt.).

11. The release liner of claim 6, wherein the photoinitiator is present in an amount of approximately 3% (wt.).

12. The release liner of claim 7, wherein the stabilizer is present in amount of approximately 0.001%-1.0% (wt.).

13. The release liner of claim 8, wherein the urethane acrylate oligomer is present in an amount of approximately 25% (wt.).

14. The release liner of claim 1, wherein the second coating is curable by actinic radiation.

15. The release liner of claim 14, wherein the actinic radiation is ultraviolet light.

16. The release liner of claim 15, wherein the ultraviolet light cures the second coating in an inert atmosphere.

17. The release liner of claim 14, where the actinic radiation is provided by an electron beam.

18. The release liner of claim 1, wherein the mixture, upon the chemical reaction between at least two pre-polymer components, forms a film.

19. The release liner of claim 8 wherein the insoluble non-mineral type particle comprises at least one insoluble organic polymer.

20. The release liner of claim 1, wherein the insoluble non-mineral type particles have an average particle size of 1 to 20 microns.

21. The release liner of claim 1, wherein the insoluble non-mineral type particles have an average particle size of 5 to 15 microns.

22. The release liner of claim 1, wherein the substrate is paper

23. The release liner of claim 1, wherein the substrate includes a polyolefin layer on at least one of the first and second surfaces.

24. The release liner of claim 1 wherein the substrate is a polymer film.

25. A release liner comprising:
a generally flat first substrate having a first side and a second side;
a first coating providing release against a pressure-sensitive adhesive, when that pressure sensitive adhesive is contacted with said first side;
a second, curable, coating for application to said second side, said second coating comprising both a mixture having two pre-polymer components, the first prepolymer component comprising at least one monomer, and the second pre-polymer component comprising either (a) at least one oligomer or (b) at least one soluble resin; and said curable, coating further comprising insoluble, non-mineral type particles within that mixture; and wherein;
the mixture further comprises a solvent or water carrier, and wherein upon the evaporation of the solvent or water carrier, the mixture forms a film.
